(19) United States
(12) Patent Application Publication
(10) Pub. No.: US 2025/0299102 A1
(43) Pub. Date: Sep. 25, 2025

(54) ACTION RECOGNIZING APPARATUS, ACTION RECOGNITION METHOD, AND PROGRAM

(71) Applicant: NEC Corporation, Tokyo (JP)

(72) Inventors: Kosuke NISHIHARA, Tokyo (JP); Kenichiro Fukushi, Tokyo (JP); Yoshitaka Nozaki, Tokyo (JP); Kensuke Wagata, Tokyo (JP); Kentaro Nakahara, Tokyo (JP)

(73) Assignee: NEC Corporation, Tokyo (JP)

(21) Appl. No.: 19/073,145

(22) Filed: Mar. 7, 2025

(30) Foreign Application Priority Data
Mar. 25, 2024 (JP) 2024-048208

(51) Int. Cl. G06N 20/00; G06F 18/213

(52) U.S. Cl. CPC G06N 20/00; G06F 18/213

(57) ABSTRACT

An action recognizing apparatus 100 of the present disclosure includes: an extracting unit 121 that extracts action feature data representing a feature of an action in each predetermined time unit from time-series action data; a converting unit 122 that converts the action feature data of each predetermined time unit into action element data; and a concatenating unit 123 that generates, as basic action data, concatenated data obtained by concatenating the action element data on a basis of a time-series array of the action element data. Thereby, basic actions can be recognized from action data, and can be used for assisting decision making.

### INCORPORATION BY REFERENCE

The present invention is based upon and claims the benefit of priority from Japanese patent application No. 2024-048208, filed on Mar. 25, 2024 in Japan, the disclosure of which is incorporated herein in its entirety by reference.

### TECHNICAL FIELD

The present disclosure relates to an action recognizing apparatus, an action recognition method, and a program.

### BACKGROUND ART

Patent Literature 1 discloses that behaviors which are actions performed by a human are recognized from a video. Specifically, in Patent Literature 1, basic actions performed by a human are recognized from skeletal information about the human in each frame of a video, and a higher-order behavior including a combination of the basic actions is recognized. At this time, for example, raising a hand, looking down, and the like are mentioned as basic actions, and work-related behaviors, suspicious behaviors, and the like are mentioned as higher-order behaviors.

### CITATION LIST

### Patent Literature

Patent Literature 1: JP 2022-3434 A

### SUMMARY OF INVENTION

### Technical Problem

However, according to the technology described in Patent Literature 1 mentioned above, basic actions have to be defined in advance, and actions cannot be recognized in a case where basic actions are not defined. As a result, a problem that actions performed by a human cannot be recognized appropriately occurs.

Therefore, one of objects of the present disclosure is to solve the problem mentioned above that actions performed by a human cannot be recognized appropriately.

### Solution to Problem

An action recognizing apparatus according to an aspect of the present disclosure includes:

an extracting unit that extracts action feature data representing a feature of an action in each predetermined time unit from time-series action data;

a converting unit that converts the action feature data of each predetermined time unit into action element data; and

a concatenating unit that generates, as basic action data, concatenated data obtained by concatenating the action element data on a basis of a time-series array of the action element data. In addition, an action recognition method according to an aspect of the present disclosure includes:

extracting action feature data representing a feature of an action in each predetermined time unit from time-series action data;

converting the action feature data of each predetermined time unit into action element data; and

generating, as basic action data, concatenated data obtained by concatenating the action element data on a basis of a time-series array of the action element data.

In addition, a program according to an aspect of the present disclosure causes a computer to execute processing to:
extract action feature data representing a feature of an action in each predetermined time unit from time-series action data;
convert the action feature data of each predetermined time unit into action element data; and
generate, as basic action data, concatenated data obtained by concatenating the action element data on a basis of a time-series array of the action element data.

### Advantageous Effects of Invention

By being configured in the manners above, the present disclosure makes it possible to appropriately recognize actions performed by a human.

### BRIEF DESCRIPTION OF DRAWINGS

FIG. 1 is a block diagram depicting the configuration of an action recognizing apparatus according to the present disclosure.

FIG. 2 is a block diagram depicting the configuration of the action recognizing apparatus according to the present disclosure.

FIG. 3 is a block diagram depicting the configuration of the action recognizing apparatus according to the present disclosure.

FIG. 4 is a block diagram depicting the configuration of the action recognizing apparatus according to the present disclosure.

FIG. 5 is a block diagram depicting the configuration of the action recognizing apparatus according to the present disclosure.

FIG. 6 is a block diagram depicting the configuration of the action recognizing apparatus according to the present disclosure.

FIG. 7 is a flowchart depicting an processing operation performed by the action recognizing apparatus according to the present disclosure.

FIG. 8 is a block diagram depicting the hardware configuration of the action recognizing apparatus according to the present disclosure.

FIG. 9 is a block diagram depicting the configuration of the action recognizing apparatus according to the present disclosure.

### DESCRIPTION OF EMBODIMENTS

### First Example Embodiment

A first example embodiment of the present disclosure is described with reference to the drawings. Note that the drawings can be related to any example embodiment.

### [Configuration]

An action recognizing apparatus 10 in the present example embodiment recognizes actions performed by a human from time-series action data of the human that can be acquired from a video or the like. Note that, hereinbelow, actions performed by a recognition-target human are referred to as higher-order actions. At this time, since each higher-order action performed by a human includes a combination of basic actions, it is necessary to recognize the basic actions from action data first, but the basic actions included in the higher-order action are unknown in some cases. In view of this, the action recognizing apparatus 10 in the present example embodiment first identifies basic actions included in a higher-order action from action data of a human.

Here, for example, examples of a higher-order action of a human which is a target of recognition by the action recognizing apparatus 10 include a nursing action performed by a nurse for a patient. Examples of a nursing action, which is a higher-order action, include “assistance in sitting up” and “body position change.” Examples of basic actions included in the higher-order action of “assistance in sitting up” include “1. raising the knees,” “2. placing the patient's hands on the stomach,” “3. turning the patient onto her/his side (turning the patient over),” “4. inserting a hand in the gap around the neck,” and “5. helping the patient to sit up,” in order. In addition, examples of basic actions included in the higher-order action of “body position change” include “1. placing an arm on her/his chest,” “2. bending the knees,” and “3. turning the patient onto her/his side,” in order. By recognizing such basic actions and higher-order actions from action data that can be acquired from a video or the like, the performance of nursing actions by a nurse can be recognized, and it is possible to assist decision making regarding subsequent nursing actions or treatment by a doctor. That is, identified basic actions are to be used for assisting decision making related to actions performed by humans such as nurses.

It should be noted that higher-order actions which are targets of recognition by the action recognizing apparatus 10 are neither limited to nursing actions performed by nurses mentioned above nor limited to actions in the medicalcare/healthcare fields, but may be any actions. In addition, basic actions included in higher-order actions identified by the action recognizing apparatus 10 from action data also are not limited to the basic actions mentioned above, but may be any actions.

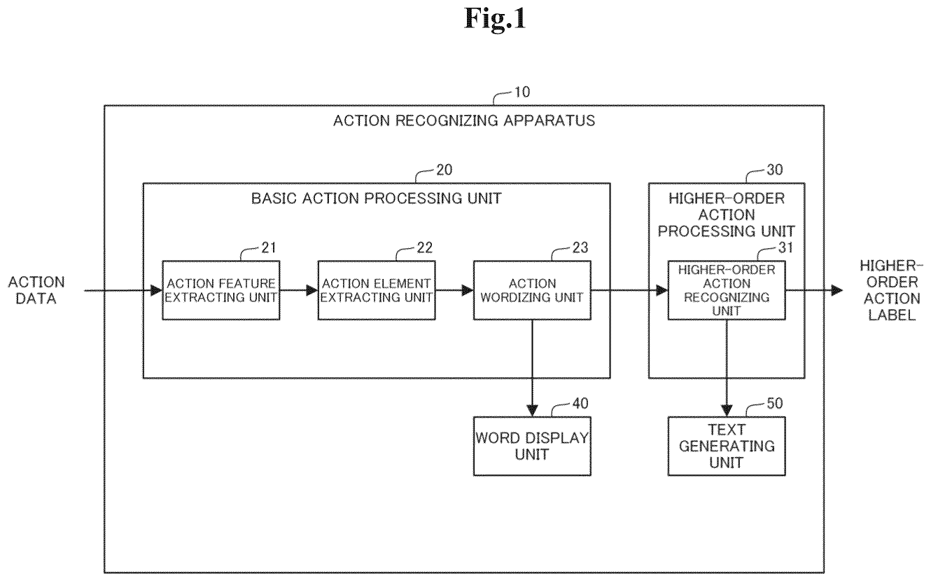

The action recognizing apparatus 10 is configured using one or more information processing apparatuses including an arithmetic apparatus and a storage apparatus. As depicted in FIG. 1, the action recognizing apparatus 10 includes a basic action processing unit 20, a higher-order action processing unit 30, a word display unit 40, and a text generating unit 50. Furthermore, the basic action processing unit 20 includes an action feature extracting unit 21, an action element extracting unit 22, and an action wordizing unit 23. In addition, the higher-order action processing unit 30 includes a higher-order action recognizing unit 31. Respective functions of the basic action processing unit 20, the higher-order action processing unit 30, the word display unit 40, and the text generating unit 50 described above can be realized by execution, by the arithmetic apparatus, of programs for realizing the respective functions stored on the storage apparatus.

First, the basic action processing unit 20 mentioned above is described. The basic action processing unit 20 is configured to receive an input of joint data which is action data of a human, and output a combination of basic actions included in a higher-order action. Specifically, the basic action processing unit 20 is configured and performs actions in the following manner.

The action feature extracting unit 21 (extracting unit) included in the basic action processing unit 20 receives an input of data of actions that are performed when a human is performing a higher-order action, and extracts, from the action data, action feature data representing features of actions in each predetermined time unit. Here, the action data includes time-series joint data of a human. For example, joints are wrists, elbows, ankles, knees, a waist, a neck, and the like, and the joint data is at least one of the positional coordinates, speeds, accelerations, angles, angular velocities, and angular accelerations of the joints. The joint data may be collected by acceleration sensors and the like, but may be collected by any method. It should be noted that the action data of the human is not limited to the joint data mentioned above, but, for example, may be data extracted from a video of actions being performed by the human, and may be any type of data as long as it is data representing actions performed by the human.

As an example, in a case where there are M types of joint data, joint data of a particular time t is called an M-dimensional vector having M types of element, and T consecutive pieces of data from the time t to a time t+T are called M×T-dimensional data. The action feature extracting unit 21 clips M×W-dimensional data (W is the window size, and W≤T) out of the input M×T dimensional data, and converts the M×W-dimensional data into an M′-dimensional vector. By repeating the clipping T′ times at consecutive times or at times that are shifted with certain intervals therebetween, M′×T′-dimensional action feature data is extracted. For example, the M′×T′-dimensional action feature data is extracted from the M×T-dimensional action data by using a convolutional neural network (CNN (Convolutional Neural Network)).

The action element extracting unit 22 (converting unit) included in the basic action processing unit 20 converts the action feature data mentioned above into action element data. As an example, the action element extracting unit 22 clusters (classifies) an input M′-dimensional vector into N classes, and outputs class IDs which are elements (action element data) corresponding to clustered classes of the input vector, and representative vectors of the relevant classes. At this time, as unsupervised clustering, a technique such as k-means or VQ-VAE (Vector Quantised-Variational AutoEncoder) is used. In the present example embodiment, as an example, each of the class IDs, which are elements, is represented by one symbol such as one numeral such as “1” or “2” or one character such as “a” or “b.” It should be noted that numerals or characters are examples, and each class ID may be one symbol of any expression. In addition, each class ID is also not limited to one symbol, but may be any type of data.

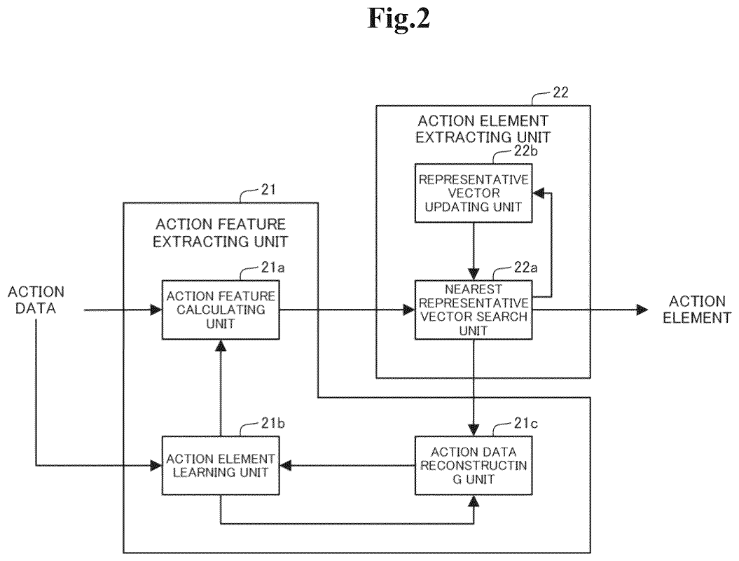

Here, the configurations of the action feature extracting unit 21 and the action element extracting unit 22 mentioned above are described further in detail. As depicted in FIG. 2, the action feature extracting unit 21 includes an action feature calculating unit 21a, an action element learning unit 21b, and an action data reconstructing unit 21c, and the action element extracting unit 22 includes a nearest representative vector search unit 22a and a representative vector updating unit 22b. Using these configurations, auto-encoder-type self-supervised learning is performed as described below.

For example, the action feature calculating unit 21a receives an input of the triaxial acceleration (M=3) of a left wrist as joint data which is action data, and outputs M′×T′-dimensional action feature data from M×T-dimensional action data using a CNN. The nearest representative vector search unit 22a searches N representative vectors for a representative vector closest to an input M′-dimensional vector, and outputs a class ID corresponding to the relevant representative vector, and the representative vector of the relevant class. That is, T′ class ID strings and T′ representative vector sequences (T′, M′×T′) are output.

The representative vector updating unit 22b calculates the average of M′-dimensional vectors of the same class ID, and updates the representative vector with the average as a new representative vector. Initial values of representative vectors are randomly initialized in advance. The action data reconstructing unit 21c reconstructs corresponding action data from the T′ representative vector sequences using a CNN. That is, the M×T-dimensional data is reconstructed from the M′×T′-dimensional data. The action element learning unit 21b calculates the difference between the reconstructed data and the input action data, and updates weights of each CNN of the action feature calculating unit 21a and the action data reconstructing unit 21c using a machine learning technique. The process mentioned above is repeated a predetermined number of times.

It becomes possible for the action feature extracting unit 21 and the action element extracting unit 22 to extract action feature data from input action data, and output class IDs which are action element data using a machine learning model generated by performing machine learning as mentioned above. For example, in a case where an input of time-series action data corresponding to a predetermined time length is received, a class ID string including arrayed class IDs which are time-series elements like [1, 2, 3, 4, 1, 2, 3, . . . 1, 5, 3, 1, 2, 3, . . . ] or [1, 1, 1, 1, 1, 1, 2, 3, 3, 3, 3, 3, 4, 6, 6, 6, 6, 6, 6, . . . ] is output.

The action wordizing unit 23 (concatenating unit) included in the basic action processing unit 20 extracts a word which is obtained by concatenating class IDs, which are plurality of elements, from a class ID string which is an array of class IDs obtained by converting action feature data into elements as mentioned above, and outputs the word as a word corresponding to a basic action. At this time, the action wordizing unit 23 extracts a word obtained by concatenating a plurality of class IDs on the basis of the state of array of class IDs in the class ID string, which is an array of elements, that is, on the basis of the state of appearance of consecutive class IDs.

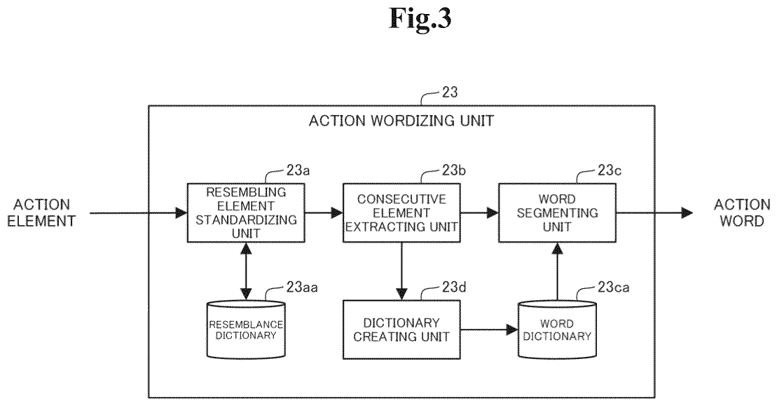

Here, the configuration of the action wordizing unit 23 mentioned above is described further in detail. As depicted in FIG. 3, the action wordizing unit 23 includes a resembling element standardizing unit 23a, a consecutive element extracting unit 23b, a word segmenting unit 23c, a dictionary creating unit 23d, a resemblance dictionary 23aa, and a word dictionary 23ca. Using these configurations, the action wordizing unit 23 performs learning to be able to extract a word from an input class ID string as described below.

The resembling element standardizing unit 23a reduces patterns to appear by standardizing class IDs which are resembling elements. Determination as to whether class IDs resemble is made on the basis of either of criteria: 1) whether the distance between vectors is equal to or shorter than a threshold; and 2) that elements appearing at statistically the same location are regarded as the same. Here, the numbers of times of appearance of N (resembling) consecutive class ID strings are counted in class ID strings including elements corresponding to entire action data. At this time, in a case where there is a first class ID string which is a class ID string with a large number of times of appearance, and there is a second class ID string which is a class ID string with a class ID configuration which is different at one position, these are compared. A numeral which is the different class ID in the second class ID string is regarded as being the same as a relevant class ID in the first class ID string with the large number of times of appearance, and the different class ID in the second class ID string is replaced with the relevant class ID in the first class ID string. For example, in a case where the number of times of consecutive appearance is N (resembling)=3, and the class ID string is [1, 2, 3, 4, 1, 2, 3, . . . 1, 5, 3, 1, 2, 3, . . . ], the class ID string [1, 2, 3] appears three times, and the class ID string [2, 3, 4] appears once. There is [1, 5, 3] as one with class IDs which are different at one position from the class ID string [1, 2, 3] with a large number of times of appearance, and “5” is replaced with “2.” Thereby, the class ID “5” is regarded as resembling the class ID “2,” and the class ID string “1, 5, 3” is changed to the class ID string “1, 2, 3,” and standardized therewith. At this time, resemblance information about class IDs, which are elements mentioned above, is registered in the resemblance dictionary 23aa.

By extracting only elements that appear consecutively a predetermined number of times, the consecutive element extracting unit 23b ignores appearances of small actions, and stabilizes wordization mentioned later. For example, only elements that appear consecutively five times are taken out, and elements that appear consecutively four times or less are deleted from an array of elements. That is, in a case where the number of times of consecutive appearance is set to N (consecutive)=5, and a class ID string is [1, 1, 1, 1, 1, 1, 2, 3, 3, 3, 3, 3, 4, 6, 6, 6, 6, 6, 6, . . . ], the class IDs “1,” “3,” and “6” appear consecutively five times or more, accordingly only the class IDs, which are elements, are extracted, and [1, 3, 6] is output.

The dictionary creating unit 23d forms a word by concatenating respective class IDs which are in the class ID string, which is an array of elements, and are elements from statistical information about the state of appearance of the class IDs, and creates the word dictionary 23ca. As a technique of class ID concatenation, a technique that is used in natural language processing such as Byte Pair Encoding (BPE), WordPiece, or SentencePiece is used. At this time, numerals which are the class IDs mentioned above may be replaced with characters. For example, a rule for replacing numerals with characters such as {1→a, 2→b, . . . } is prepared in advance. Thereby, the class ID string [1, 3, 6] can be replaced with [acf], and the SentencePiece library of python or the like can be applied as it is.

Note that N (resembling), N (consecutive), and the like mentioned above are ones that are given in advance as hyperparameters, and, other than these, a word count in SentencePiece is given in advance as a hyperparameter. In order to obtain an expected output, these hyperparameters need to be set correctly. Because of this, an expected word-appearance pattern is given in advance for sample action data whose action pattern is known in advance, and the process performed by the resembling element standardizing unit 23a, the consecutive element extracting unit 23b, and the dictionary creating unit 23d are repeated as mentioned above while changing the values the hyperparameters in such a manner that the output is obtained.

On the basis of the word dictionary 23ca, the word segmenting unit 23c segments a class ID string, which is an array of elements, into words. For example, 1) matching of words in the dictionary is performed starting from the longest words in the dictionary; 2) a combination with a high probability of appearance is chosen using the Unigram language model or the Bigram language model; 3) SentencePiece is used. Thereby, a class ID string corresponding to basic actions like “1, 3, 6” or [acf] can be extracted from class ID strings such as [1, 2, 3, 4, 1, 2, 3, . . . 1, 5, 3, 1, 2, 3, . . . ] or [1, 1, 1, 1, 1, 1, 2, 3, 3, 3, 3, 3, 4, 6, 6, 6, 6, 6, 6, . . . ] mentioned above.

In the manner mentioned above, the basic action processing unit 20 of the action recognizing apparatus 10 can identify a class ID string corresponding to basic actions from action data even in a case where the basic actions that can be included in a higher-order action are unknown. The basic action processing unit 20 can output a combination of basic actions that can be included in a higher-order action.

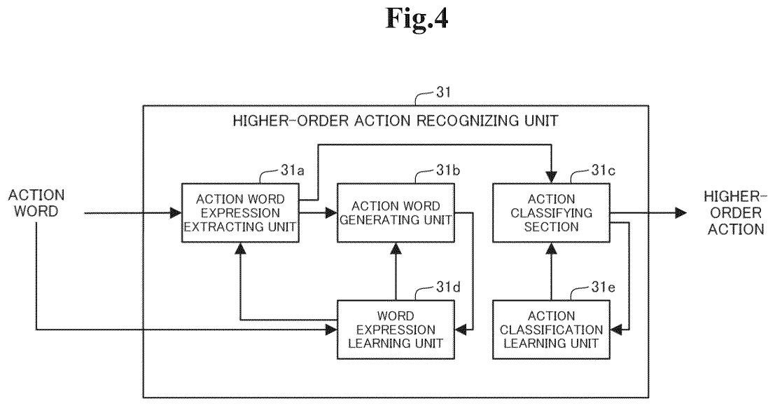

Next, the higher-order action processing unit 30 mentioned above is described. As mentioned above, the higher-order action processing unit 30 includes the higher-order action recognizing unit 31 (recognizing unit) depicted in FIG. 1, and furthermore, as depicted in FIG. 4, the higher-order action recognizing unit 31 includes an action word expression extracting unit 31a, an action word generating unit 31b, an action classifying section 31c, a word expression learning unit 31d, and an action classification learning unit 31e. With the configuration, learning to generate a recognition model for recognizing a higher-order action corresponding to a combination of a plurality of words that are consecutively ordered along a times series is performed, and, using the recognition model, a higher-order action is recognized from a combination of words which are a combination of basic actions output from the basic action processing unit 20.

Note that a technique such as BERT or GPT used in natural language processing is used as the recognition model, and, in the learning stage, BERT-type prior learning and classification of higher-order action labels are performed. At this time, there are action data having corresponding higher-order action labels, and action data not having corresponding higher-order action labels. In the higher-order action recognition learning procedure, there are input word strings corresponding to the flows of actions having corresponding higher-order action labels and input word strings corresponding to the flows of actions not having corresponding higher-order action labels. Those not having higher-order action labels (unlabeled) are used for learning of action word expressions, and those having higher-order action labels (labeled) are used for learning of higher-order action classification.

The action word expression extracting unit 31a outputs different vectors for different word strings. It is assumed that these are called action word expression vectors. A BERT-type network architecture is used here. That is, an action word string is converted into an embedded vector, and is converted into an action word expression vector using a neural network called Transformer.

The action word generating unit 31b generates a word string from an action word expression vector using a fully connected neural network (FC). The word expression learning unit 31d compares the generated word string and an input word string, and, by a machine learning technique, updates the embedded vector of the action word expression extracting unit 31a and weights of Transformer, and weights of the FC of the action word generating unit 31b. The process described above is repeated a predetermined number of times for unlabeled data. Thereby, the input word string can be converted into an action word expression vector.

In addition, the action word expression extracting unit 31a outputs an action word expression vector for a labeled word string. The action classifying section 31c generates an action label of a higher-order action from an input of an action word expression vector using the FC. The action classification learning unit 31e compares the generated action label and an input action label, and updates weights of the FC of the action classifying section 31c by a machine learning technique. At this time, the embedded vectors of the action word expression extracting unit 31a and weights of Transformer may be updated. The process mentioned above is repeated a predetermined number of times for a labeled word string. Thereby, the higher-order action recognizing unit 31 can output a higher-order action recognition result for an input of a word string including a combination of basic actions.

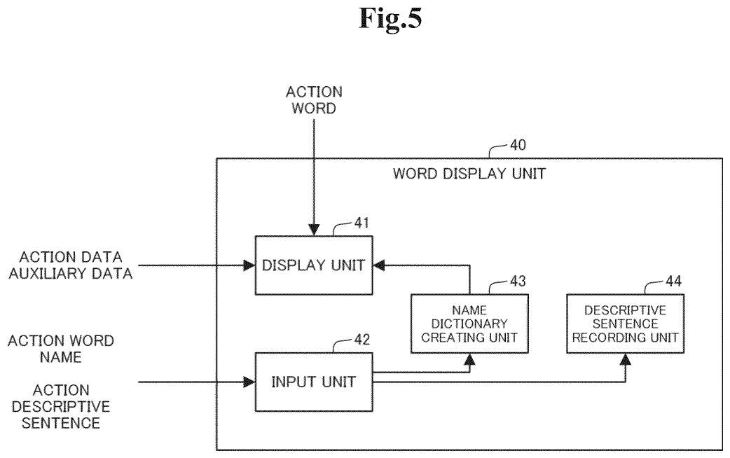

Next, the word display unit 40 mentioned above is described. As depicted in FIG. 5, the word display unit 40 includes a display unit 41, an input unit 42, a name dictionary creating unit 43, and a descriptive sentence recording unit 44. With the configuration, a word corresponding to basic actions generated from action data as mentioned above, and a video based on action data corresponding to the word are output. Hereinbelow, respective configurations are described.

The display unit 41 displays a word string from the action wordizing unit 23, and action data or auxiliary data corresponding to the action data. At this time, for example, the auxiliary data is video data capturing a human who is performing an action of measured action data or is video data representing an action performed by a human generated by motion capture on the basis of the action data. That is, the display unit 41 outputs a word identified as basic actions from action data as mentioned above and video data at the time of the actions corresponding to the word. At this time, in a case where a name and a descriptive sentence have already been registered for the word in the dictionary as mentioned later, the name and the descriptive sentence are also displayed together.

The input unit 42 accepts an input of a name of a displayed word and a descriptive sentence of the word. That is, the word “acf” generated as mentioned above does not have a meaning, but an input of a name and a descriptive sentence having meanings representing the content of actions corresponding to the word is accepted. Note that the input unit 42 accepts an input in a case where a name and the like of a word have not been registered or are to be changed.

The name dictionary creating unit 43 records the name of the input word, and creates an action word name dictionary. The descriptive sentence recording unit 44 records the descriptive sentence of the input word. At this time, the name and the descriptive sentence of the input word are recorded in association with the corresponding word and a corresponding video.

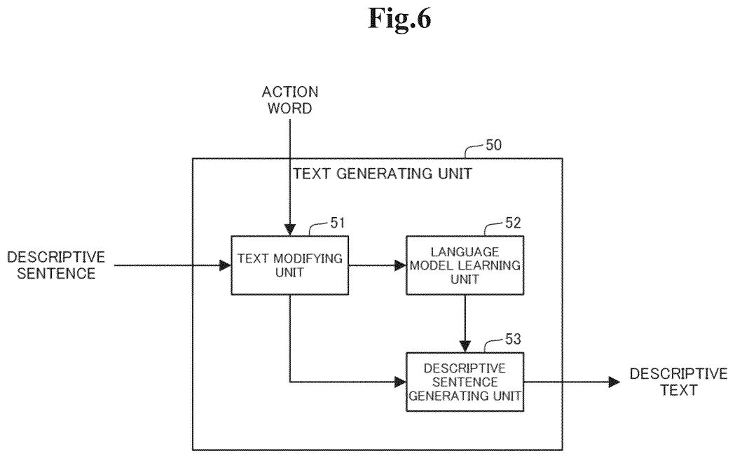

Next, the text generating unit 50 mentioned above is described. As depicted in FIG. 6, the text generating unit 50 includes a text modifying unit 51, a language model learning unit 52, and a descriptive sentence generating unit 53. With the configuration, a descriptive text of a recognized higher-order action is generated and output. Hereinbelow, respective configurations are described.

The text modifying unit 51 modifies texts into a format appropriate for language model learning from a word string and a descriptive text. For example, the text modifying unit 51 modifies texts into a format corresponding to any of: 1) a GPT (Generative Pretrained Transformer)-type network architecture; and 2) trained large language model (LLM (Large language Models)) fine tuning. At the learning phase, in the case of 1), a format obtained by concatenating a word string and a descriptive sentence is adopted, and, in the case of 2), a format in which a pair of a word string as a question (prompt) and a descriptive text as a response sentence (completion) is generated is adopted. As the trained LLM, for example, Llama2 or the like can be used.

The language model learning unit 52 performs learning of a language model that generates a descriptive text from a word string. Specifically, the language model learning unit 52 performs language model learning using, as inputs, word strings used for recognition of higher-order actions and descriptive texts recorded corresponding to respective words.

The descriptive sentence generating unit 53 generates a descriptive text by giving a word string. Specifically, the descriptive sentence generating unit 53 generates a descriptive text from an action word string using the language model mentioned above. That is, from newly-input action data, a text describing an action thereof can be generated.

### [Operation]

Next, an operation to recognize a higher-order action from action data of a human performed by the action recognizing apparatus 10 is described. Note that it is assumed that each unit of the action recognizing apparatus 10 has been trained by the process mentioned above.

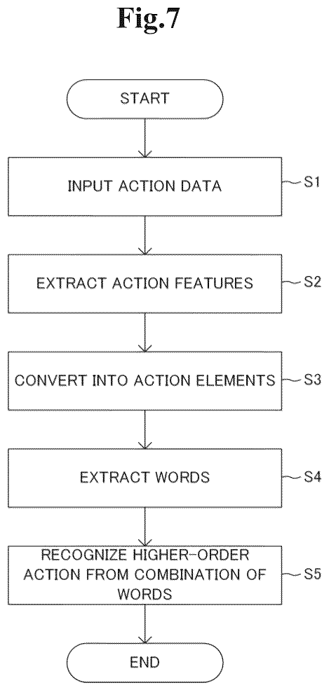

Upon reception of an input of the action data of the human by the action recognizing apparatus 10 (step S1 in FIG. 7), first, the action feature extracting unit 21 extracts action feature data representing features of actions for each predetermined time unit (step S2 in FIG. 7). The action element extracting unit 22 converts each piece of action feature data into action element data such as one numeral or character (step S3 in FIG. 7). Thereby, a class ID string which is an array of numerals or characters is generated.

Next, the action wordizing unit 23 extracts a word which is obtained by concatenating a plurality of numerals or characters from the class ID string, which is an array of numerals or characters (step S4 in FIG. 7). At this time, the action wordizing unit 23 extracts the word on the basis of the state of array in the array of numerals or characters. In addition, at this time, the word is extracted by standardizing resembling elements or treating only consecutively-appearing elements in the array of numerals or characters. The thus-generated word represents a basic action.

Next, the action recognizing apparatus 10 inputs, to the higher-order action recognizing unit 31, a word string, that is, a combination of words, generated along the time series of action data. Thereby, a higher-order action recognized by the higher-order action recognizing unit 31 is output (step S5 in FIG. 7).

Note that the action recognizing apparatus 10 may output words and a corresponding video generated by the word display unit 40 in addition to the higher-order action recognition result mentioned above. In addition, the action recognizing apparatus 10 may output a descriptive text corresponding to the higher-order action generated by the text generating unit 50, in addition to the higher-order action recognition result.

As mentioned above, the action recognizing apparatus 10 in the present example embodiment can identify basic actions even in a case where basic actions that can be included in a higher-order action are unknown, and can appropriately recognize the higher-order action performed by a human using the identified basic actions.

### Second Example Embodiment

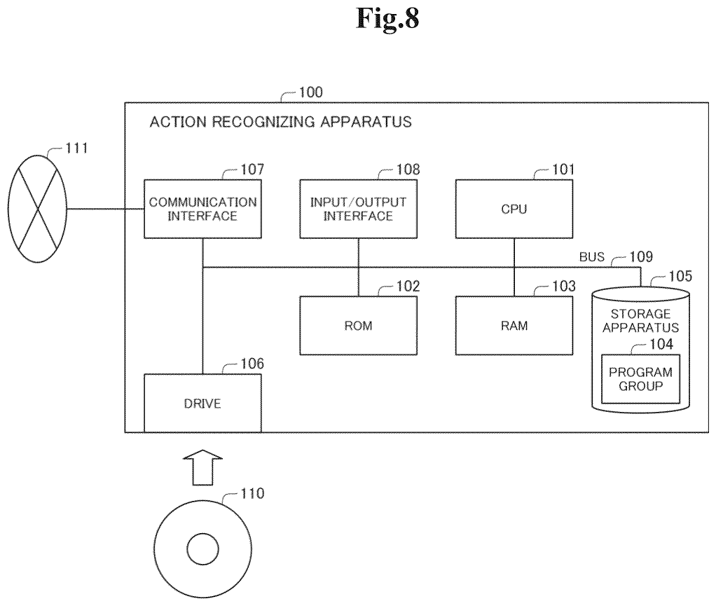

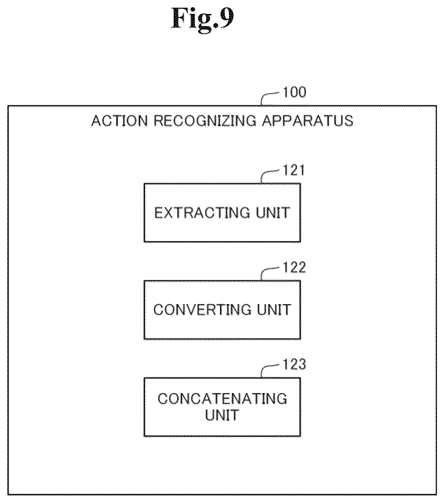

Next, a second example embodiment of the present disclosure is described with reference to drawings. An outline of the configuration of the action recognizing apparatus described in the example embodiment mentioned above is depicted in the present example embodiment. Note that FIG. 8 to FIG. 9 are figures for describing the configuration, and the drawings can be related to any of the example embodiments.

First, the hardware configuration of an action recognizing apparatus 100 is described with reference to FIG. 8. The action recognizing apparatus 100 is configured using a typical information processing apparatus, and has a hardware configuration as described below as an example.
Central Processing Unit (CPU) 101 (arithmetic apparatus)
Read Only Memory (ROM) 102 (storage apparatus)
Random Access Memory (RAM) 103 (storage apparatus)
Program group 104 to be loaded to RAM 103
Storage apparatus 105 having stored thereon the program group 104
Drive 106 that performs reading and writing on a storage medium 110 outside the information processing apparatus
Communication interface 107 connected to a communication network 111 outside the information processing apparatus
Input/output interface 108 for performing input/output of data
Bus 109 connecting the respective constituent elements

Note that FIG. 8 depicts an example of the hardware configuration of the information processing apparatus that is the action recognizing apparatus 100. The hardware configuration of the information processing apparatus is not limited to that mentioned above. For example, the information processing apparatus may be configured using part of the configuration mentioned above, such as without the drive 106. In addition, instead of the CPU mentioned above, the information processing apparatus can use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, a combination of these, or the like.

The action recognizing apparatus 100 can construct and be equipped with an extracting unit 121, a converting unit 122, and a concatenating unit 123 depicted in FIG. 9 through acquisition of the program group 104 and execution thereof by the CPU 101. Note that the program group 104 is stored on, for example, the storage apparatus 105 or the ROM 102 in advance, is loaded to the RAM 103 by the CPU 101, and is executed by the CPU 101 as needed.

In addition, the program group 104 may be supplied to the CPU 101 via the communication network 111, or the programs may be stored on the storage medium 110 in advance, read out by the drive 106, and supplied to the CPU 101. It should be noted that the extracting unit 121, the converting unit 122, and the concatenating unit 123 mentioned above may be constructed using electronic circuits dedicated for realizing the means.

The extracting unit 121 extracts action feature data representing features of an action in each predetermined time unit from time-series action data. The converting unit 122 converts the action feature data of each predetermined time unit into action element data. On the basis of a time-series array of the action element data, the concatenating unit 123 generates, as basic action data, concatenated data which is obtained by concatenating the action element data.

By being configured in the manner above, the present disclosure can identify basic actions even in a case where basic actions that can be included in a higher-order action are unknown, and can appropriately recognize the higher-order action performed by a human using the identified basic actions.

Note that at least one or more functions of the functions of the extracting unit 121, the converting unit 122, and the concatenating unit 123 mentioned above may be executed at an information processing apparatus installed and connected at any location on a network, that is, may be executed by so-called cloud computing.

In addition, the programs mentioned above can be supplied to a computer by being stored using a non-transitory computer readable medium (non-transitory computer readable medium) of any type. Non-transitory computer readable media include tangible recording media (tangible storage media) of various types. Examples of non-transitory computer readable media include a magnetic recording medium (e.g. flexible disc, magnetic tape, hard disk drive), a magneto-optical recording medium (e.g. magneto-optical disc), a CD-ROM (Read Only Memory), a CD-R, a CD-R/W, and a semiconductor memory (e.g. mask ROM, PROM (Programmable ROM), EPROM (Erasable PROM), flash ROM, and RAM (Random Access Memory)). In addition, the programs may also be supplied to a computer by being stored on a transitory computer readable medium (transitory computer readable medium) of any type. Examples of transitory computer readable media include electric signals, optical signals, and electromagnetic waves. A transitory computer readable medium can supply programs to a computer via a wired communication channel such as an electric wire or an optical fiber, or a wireless communication channel.

While the present disclosure has been described thus far with reference to the example embodiments and the like described above, the present disclosure is not limited to the example embodiments mentioned above. The configurations and details of the present disclosure can be changed within the scope of the present disclosure in various manners that can be understood by those skilled in the art. Each example embodiment mentioned above can be combined with another example embodiment as appropriate.

### Supplementary Notes

Part of or the whole of the example embodiments described above can also be described as in the following supplementary notes. Hereinbelow, outlines of the configurations of an action recognizing apparatus, an action recognition method, and a program according to the present disclosure are described. It should be noted that the present disclosure is not limited to the following configurations.

### (Supplementary Note 1)

An action recognizing apparatus including:
an extracting unit that extracts action feature data representing a feature of an action in each predetermined time unit from time-series action data;
a converting unit that converts the action feature data of each predetermined time unit into action element data; and
a concatenating unit that generates, as basic action data, concatenated data obtained by concatenating the action element data on a basis of a time-series array of the action element data.

### (Supplementary Note 2)

The action recognizing apparatus according to supplementary note 1, in which
the converting unit classifies the action feature data into a class on a basis of the action feature data, and converts the action feature data into the action element data represented by a symbol in a preset unit corresponding to the class, and
the concatenating unit generates the concatenated data represented by a symbol string obtained by concatenating a plurality of the symbols on a basis of a time-series array of the symbols corresponding to the action data.

### (Supplementary Note 3)

The action recognizing apparatus according to supplementary note 2, in which
the concatenating unit generates the symbol string which is the concatenated data to be treated as the basic action data on a basis of a state of appearance of the symbol string in the array of symbols.

### (Supplementary Note 4)

The action recognizing apparatus according to supplementary note 2, in which
the concatenating unit changes the symbols in a predetermined symbol string, and standardize a plurality of the symbol strings on a basis of comparison of the symbol strings in the array of symbols.

### (Supplementary Note 5)

The action recognizing apparatus according to supplementary note 2, in which
the concatenating unit generates the symbol string using only the symbols that appear consecutively at least a predetermined number of times in the array of symbols.

### (Supplementary Note 6)

The action recognizing apparatus according to supplementary note 2, including:
an output unit that outputs a video based on the action data corresponding to the symbol string along with the symbol string.

### (Supplementary Note 7)

The action recognizing apparatus according to supplementary note 6, in which
the output unit associates input descriptive information with the symbol string and the video that are output.

### (Supplementary Note 8)

The action recognizing apparatus according to supplementary note 2, in which
the converting unit classifies the action feature data into a class using a machine learning model.

### (Supplementary Note 9)

The action recognizing apparatus according to supplementary note 2, including:
a recognizing unit that recognizes a higher-order action on a basis of a combination of the symbol strings.

### (Supplementary Note 10)

An action recognition method including:
extracting action feature data representing a feature of an action in each predetermined time unit from time-series action data;
converting the action feature data of each predetermined time unit into action element data; and
generating, as basic action data, concatenated data obtained by concatenating the action element data on a basis of a time-series array of the action element data.

### (Supplementary Note 11)

The action recognition method according to supplementary note 10, including:
classifying the action feature data into a class on a basis of the action feature data, and converting the action feature data into the action element data represented by a symbol in a preset unit corresponding to the class; and
generating the concatenated data represented by a symbol string obtained by concatenating a plurality of the symbols on a basis of a time-series array of the symbols corresponding to the action data.

### (Supplementary Note 12)

The action recognition method according to supplementary note 11, including:
generating the symbol string which is the concatenated data to be treated as the basic action data on a basis of a state of appearance of the symbol string in the array of symbols.

### (Supplementary Note 13)

The action recognition method according to supplementary note 11, including:
outputting a video based on the action data corresponding to the symbol string along with the symbol string.

### (Supplementary Note 14)

The action recognition method according to supplementary note 11, including:
recognizing a higher-order action on a basis of a combination of the symbol strings.

### (Supplementary Note 15)

A program including instructions for causing a computer to execute processing to:
extract action feature data representing a feature of an action in each predetermined time unit from time-series action data;
convert the action feature data of each predetermined time unit into action element data; and
generate, as basic action data, concatenated data obtained by concatenating the action element data on a basis of a time-series array of the action element data.

### REFERENCE SIGNS LIST

10: action recognizing apparatus
20: basic action processing unit
21: action feature extracting unit
21a: action feature calculating unit
21b: action element learning unit
21c: action data reconstructing unit
22: action element extracting unit
22a: nearest representative vector search unit
22b: representative vector updating unit
23: action wordizing unit
23a: resembling element standardizing unit
23b: consecutive element extracting unit
23c: word segmenting unit
23d: dictionary creating unit
23aa: resemblance dictionary
23ca: word dictionary
30: higher-order action processing unit
31: higher-order action recognizing unit
31a: action word expression extracting unit
31b: action word generating unit
31c: action classifying section
31d: word expression learning unit
31e: action classification learning unit
40: word display unit
41: display unit
42: input unit
43: name dictionary creating unit
44: descriptive sentence recording unit
50: text generating unit
51: text modifying unit
52: language model learning unit
53: descriptive sentence generating unit
100: action recognizing apparatus
101: CPU
102: ROM
103: RAM
104: program group
105: storage apparatus
106: drive
107: communication interface
108: input/output interface
109: bus
110: storage medium
111: communication network
121: extracting unit
122: converting unit
123: concatenating unit

1. An action recognizing apparatus comprising:
at least one memory configured to store instructions; and
at least one processor configured to execute instructions to:
extract action feature data representing a feature of an action in each predetermined time unit from time-series action data;
convert the action feature data of each predetermined time unit into action element data; and
generate, as basic action data, concatenated data obtained by concatenating the action element data on a basis of a time-series array of the action element data.

2. The action recognizing apparatus according to claim 1, wherein
the at least one processor is configured to execute the instructions to:
classify the action feature data into a class on a basis of the action feature data, and convert the action feature data into the action element data represented by a symbol in a preset unit corresponding to the class, and
generate the concatenated data represented by a symbol string obtained by concatenating a plurality of the symbols on a basis of a time-series array of the symbols corresponding to the action data.

3. The action recognizing apparatus according to claim 2, wherein
the at least one processor is configured to execute the instructions to generate the symbol string which is the concatenated data to be treated as the basic action data on a basis of a state of appearance of the symbol string in the array of symbols.

4. The action recognizing apparatus according to claim 2, wherein
the at least one processor is configured to execute the instructions to change the symbols in a predetermined symbol string, and standardize a plurality of the symbol strings on a basis of comparison of the symbol strings in the array of symbols.

5. The action recognizing apparatus according to claim 2, wherein
the at least one processor is configured to execute the instructions to generate the symbol string using only the symbols that appear consecutively at least a predetermined number of times in the array of symbols.

6. The action recognizing apparatus according to claim 2, wherein
the at least one processor is configured to execute the instructions to output a video based on the action data corresponding to the symbol string along with the symbol string.

7. The action recognizing apparatus according to claim 6, wherein
the at least one processor is configured to execute the instructions to associate input descriptive information with the symbol string and the video that are output.

8. The action recognizing apparatus according to claim 2, wherein
the at least one processor is configured to execute the instructions to classify the action feature data into a class using a machine learning model.

9. The action recognizing apparatus according to claim 2, wherein
the at least one processor is configured to execute the instructions to recognize a higher-order action on a basis of a combination of the symbol strings.

10. An action recognition method comprising:
extracting action feature data representing a feature of an action in each predetermined time unit from time-series action data;
converting the action feature data of each predetermined time unit into action element data; and
generating, as basic action data, concatenated data obtained by concatenating the action element data on a basis of a time-series array of the action element data.

11. A program comprising instructions for causing a computer to execute processing to:
extract action feature data representing a feature of an action in each predetermined time unit from time-series action data;
convert the action feature data of each predetermined time unit into action element data; and
generate, as basic action data, concatenated data obtained by concatenating the action element data on a basis of a time-series array of the action element data.
